(19) United States
(12) Patent Application Publication
(10) Pub. No.: US 2018/0034055 A1
(43) Pub. Date: Feb. 1, 2018

(54) COMPOSITE INCLUDING POROUS GRAPHENE AND CARBON NANOTUBE MATERIAL

(71) Applicant: University-Industry Foundation, Yonsei University, Seoul (KR)

(72) Inventors: Kwang Bum KIM, Seoul (KR); Yeon Jun CHOI, Seoul (KR)

(21) Appl. No.: 15/281,390

(22) Filed: Sep. 30, 2016

(30) Foreign Application Priority Data
Jul. 28, 2016 (KR) 10-2016-0095848

(51) Int. Cl. H01M 4/583; H01G 11/24; H01G 11/36; H01M 4/36

(52) U.S. Cl. CPC H01M 4/583; H01M 4/366; H01G 11/24; H01G 11/36

(57) ABSTRACT

A graphene composite of a porous structure includes a laminate which is laminated by two or more layers of reduced graphene (rGO) in which a plurality of holes are formed and carbon nanotubes present in the interface(s) between the layers of the reduced graphene (rGO) forming the laminate. An electrode made of the composite is also provided. The graphene composite of a porous structure includes the graphene forming a number of holes to increase the surface area, and includes the carbon nanotubes present in the interface(s) between the layers of graphene (rGO) to inhibit re-lamination of the graphene and widen the contact area of the electrolyte, so that the electrolyte is easily penetrated. Thus, the ionic conductivity is improved, and on preparing an electrode, it is possible to provide an electrode with improved electrochemical properties.

### CROSS-REFERENCE TO RELATED APPLICATIONS

This application claims priority under 35 USC § 119(a) of a Korean Patent Application No. 10-2016-0095848 filed on Jul. 28, 2016, the subject matter of which is hereby incorporated by reference,

### BACKGROUND

### Field of the Invention

The present invention relates to a composite comprising porous graphene and carbon nanotubes and an electrode comprising the composite.

### Background Art

Recently, interest in energy storing technology is more rising,. While its application fields extend to energy for mobile phones, camcorders and notebook PCs, and further electric vehicles, efforts for research and development of electrochemical devices are more embodied. In this aspect, the electrochemical device is a field receiving the most attention, inter alia, the development of rechargeable secondary batteries is being the focus of attention, and recently, in developing such a battery, the design of new electrodes and batteries is subjected to research and development to increase charge-discharge capacity.

In general, electrode materials of energy storage media, such as electric double layer capacitors and fuel cells express excellent properties, if a moving passage of electrolyte ions is secured and the area being adsorptive to a surface (effective specific surface area) is wide. In addition, such an electrode material has an improved capacity characteristic, with having more excellent electrical conductivity. For example, conventionally, high electrically conductive material such as carbon black was mixed and used as the electrode material.

Furthermore, carbon materials such as graphenes, fullerenes or carbon nanotubes have so excellent physical properties that they can be applied to a wide range of fields such as solar cells, FED (field emission device), capacitors or batteries, for which studies are actively proceeding.

The graphene and the carbon nanotubes are spotlighted as materials having an excellent electrical conductivity, 100 times or more as high as one of copper, and a large specific surface area. For use as the electrode materials of the energy storage media, when such, a nanomaterial, such as graphene and carbon nanotubes, is structured, a pore structure having easy movement of the electrolyte ions can be not only secured, but also the capacity characteristics can be maximized because of excellent electrical conductivity to smooth movement of elections.

The method of synthesizing the carbon nanotubes includes a method of synthesizing carbon nanotubes by supporting a transition metal (Fe, Co, or Ni) on a metal oxide support (Al₂P₃ or MgO) to generate a metal oxide/metal catalyst carrier, and exposing to hot carbon source/reacting this. When the carbon nanotubes are synthesized as such, the carbon nanotubes can be obtained in a high yield of 500% or more. However, in this case of the synthesized carbon nanotubes as such, the metal oxide used as the support for supporting the metal catalyst itself serves as inorganic impurities to inhibit the purity of the carbon nanotubes. Accordingly, since a complicated purification process to remove the inorganic impurities may be required, it is advantageous in various applications of carbon nanotubes later to synthesize carbon nanotubes with high yield, while minimizing usage of the unnecessary metal oxide.

If the support for supporting the transition metal is replaced with a heterogeneous carbon material having the same ingredient as carbon nanotubes other than the metal oxide, it is also possible without carrying out the separate purification process to improve the purity of the synthesized carbon nanotubes over the prior art. Moreover, since the support itself is a thermally conductive and electrically conductive material, it can serve as the conductive filler other than impurities, even if the phenomenon that the support is detached from the carbon nanotubes occurs.

However, it is very unstable in terms of reproducibility and reliability to uniformly support the transition metal on the carbon material having low reactivity. Accordingly, the carbon nanotubes have been synthesized by surface treating the carbon material, and methods of depositing a transition metal precursor such as ferrocene directly to the carbon material through a physical adsorption process at elevated temperature or supporting the transition metal after surface treating the surface of the carbon material using introduction of a functional group through a chemical treatment, introduction of an organic buffer layer or plating, and the like have been applied.

For such surface-treated carbon materials, they were effective in the impurity problem, but the yield of the carbon nanotubes after synthesizing the carbon nanotubes is 100% or less relative to the initial catalyst support weight, so that it was problematic to synthesize carbon nanotubes with high yield in terms of carbon materials.

Therefore, it is required that a composite of new structure having high capacity and high efficiency and an electrode using the same is developed by forming graphene and carbon nanotubes into a composite using new method rather than the method of growing carbon nanotubes,

### SUMMARY OF THE INVENTION

### Technical Problem

It is an object of the present invention to provide a composite having high specific surface area to which an electrolyte is easily penetrated, and an electrode having excellent electrochemical properties comprising the same.

### Technical Solution

In order to solve the above problem, the present invention provides a graphene composite of a porous structure comprising a laminate which is laminated by two or more layers of reduced graphene (rGO) in which a plurality of holes are formed; and carbon nanotubes present in the interface(s) between the layers of the reduced graphene (rGO) forming the laminate.

The present invention also provides an electrode comprising the graphene composite of a porous structure.

### Effect or the Invention

The graphene composite of a porous structure according to the present invention includes the reduced graphene layers forming, a number of holes to increase the surface area, and includes the carbon nanotubes present in the interface(s) between the lays of the reduced graphene (rGO) to inhibit re-lamination of the graphene and widen the contact area of the electrolyte so that the electrolyte is easily penetrated. Accordingly, the ionic conductivity is improved, and on preparing an electrode, it is possible to provide an electrode with improved electrochemical properties.

### BRIEF DESCRIPTION OF DRAWINGS

FIG. 1 is a TEM photograph of the composite prepared according to Example 1.

FIG. 2 is a graph of the results analyzing X-ray photoelectron spectroscopy (XPS) of the composite according to Example 1.

FIG. 3 simply shows procedures of preparing a composite according to the present invention.

FIG. 4 is the result of N₂ adsorption isotherms (sorption isotherms) of the composites according to Example 1, Example 2 and Comparative Example 1.

FIG. 5 is a graph measuring the pore volume and the average pore diameter of the composites according to Examples 1, and 2 and Comparative Example 1.

FIG. 6 is charge-discharge curves for a full cell according to Example 3.

FIG. 7 is charge-discharge curves for a full cell according to Comparative Example 4.

FIG. 8 is charge-discharge curves of a full cell according to Example 3 (A), a full cell according to Comparative Example 3 (C) and a full cell produced by only the graphene (D).

FIG. 9 is a graph of specific capacitances of a full cell according to Example 3 (A), a full cell according to Comparative Example 3 (C) and a full cell produced by only the graphene (D).

FIG. 10 is cyclic voltammograms of a hill cell according to Example 3.

FIG. 11 depicted electrochemical impedance spectroscopy (EIS) data of full cells according to Example 3 and Comparative Example 3.

### DETAILED DESCRIPTION OF THE INVENTION

Hereinafter, the present invention is explained in more detail.

The present invention relates to a graphene composite of porous structure and an electrode comprising the same.

In the graphene composite of a porous structure according to the present invention comprises a laminate which is laminated by two or more layers of reduced graphene (rGO) in which a plurality of holes are formed; and carbon nanotubes present in the interface(s) between the layers of the reduced graphene (rGO) forming the laminate. Specifically, the graphene composite of porous structure may be one that the graphene forming a number of holes is laminated in the range of 2 to 50 layers, 3 to 40 layers, 5 to 30 layers or 7 to 20 layers. The structure of the graphene composite of porous structure may be one that carbon nanotubes are dispersed between layers of each graphene. The carbon nanotubes serve as spacer between layers of each graphene to inhibit re-lamination of the graphene so that the electrolyte is easily moved through holes of the graphene.

In the present invention, the graphene may refer to the reduced graphene (rGO).

The BET specific surface area in the graphene composite of porous structure may be in the range of 100 to 700 m²g. Specifically, the BET specific surface area may be in the range of 150 to 600 m²/g, 180 to 550 m²/g, 200 to 530 ²/g, 230 to 500 m²/g, 250 to 480 m²/g, 280 to 450 m²/g, 300 to 430 m²/g, 310 to 410 m²/g or 370 to 400 m²/g. In the graphene composite of porous structure according to the present invention, the graphene layers forming a number of holes form carbon nanotubes in the interfaces of each layer, which can satisfy the above range of wide BET specific surface area, and the contact area of the electrolyte is increased due to such a specific surface area to thereby improve the ion conductivity and electrical conductivity.

The graphene composite of porous structure according to the present invention may have the average diameter of pores consisting of the porous structure in the range of 1 to 40 nm. Specifically the average diameter of pores may be in the range of 2 to 35 nm, 3 to 30 nm, 6 to 28 nm, 6.5 to 25 nm, 6.8 to 23 nm, 7 to 20 nm, 7.3 to 18 nm, or 8 to 15 nm. In addition, the pores may have roughly spherical shape, and these pores may be those formed due to the metal oxide nanoparticles having a particle size of the average diameter range of the pores.

As one example, the pores formed in the graphene composite of porous structure according to the present invention may include 10 to 50% of the pores having an average diameter of 0.1 to 5 nm and 20 to 80% of the pores having an average diameter of 5 to 20 nm in all the pores present in the graphene composite of porous structure. Specifically, the graphene composite of porous structure according the present invention may include 15 to 45%, 20 to 40% or 25 to 30% of the pores having an average diameter of 0.1 to 5 nm and 20 to 80%, 25 to 75%, 30 to 70% or 35 to 65% of the pores having an average diameter of 5 to 20 nm in all the pores. The graphene composite of porous structure according to the invention may include a number of pores having a relatively large diameter in the above range to improve the specific surface area, and thereby expands the contact area with the electrolyte to increase the ionic conductivity and the electrical conductivity. In addition, such a graphene composite of porous structure exhibits excellent electrochemical properties on manufacturing the electrode.

The content ratio of the reduced graphene (rGO) and the carbon nanotubes in the graphene composite of porous structure according to the present invention may be in the range of 10:0.5˜9 (by weight). Specifically, the content ratio may be in the range of 10:1˜8, 10:1.5˜7, 10:1.8˜6, 10:2˜5 or 10:2˜4.

As one example, the content of the carbon nanotubes may be 5 to 90 parts by weight based on 100 parts by weight of the graphene. Specifically, the content of the carbon nanotubes may be 10 to 80 parts by weight, 15 to 70 parts by weight, 20 to 50 weight parts or 20 to 40 parts by weight based on 100 parts by weight of the, graphene. If the graphene and the carbon nanotubes are present in the above range in the composite according to the invention present, the relatively large pores are formed in the graphene composite of porous structure to effectively enhance the specific surface area, so that the excellent electrochemical properties can be embodied.

The average diameter of the carbon nanotubes according to the present invention may be in the range 1 to 50 nm. Specifically, the average diameter of the carbon nanotubes may be in the range of 5 to 45 nm, 8 to 40 nm, 10 to 35 nm or 15 to 25 nm. The diameter of carbon nanotubes can mean the average diameter of a cross section perpendicular to the longitudinal direction of the carbon nanotubes. When the diameter of the carbon nanotube according to the present invention is in the above range, the re-lamination of the graphene may be easily inhibited, and the relatively large pores are easily formed in the graphene composite of porous structure.

In addition, the average diameter of holes formed in the graphene may be in the range of 0.5 to 40 nm, and specifically, the average diameter of the holes may be in the range of 1 to 35 nm, 2 to 30 nm, 5 to 25 nm or 7 to 20 nm. Also, the pores may have roughly spherical shape, and these pores may be those formed due to the metal oxide nanoparticles having a particle size of the average diameter range of the pores.

In the present invention, the graphene may be negatively charged on the surface, and the carbon nanotubes may be positively charged on the surface. The dispersion force of the carbon nanotubes and the graphene may be increased by having charges different from each other on their surfaces to inhibit aggregation of carbon nanotubes themselves, and different charges can facilitate formation of the graphene and the carbon nanotubes into a composite.

The present invention provides a process for producing a graphene composite of porous structure.

The process for producing a graphene composite of porous structure according to the present invention may comprises

a first step of preparing a dispersion of graphene or graphite oxide;

a second step of preparing a metal salt solution and a disperse solution of carbon nanotubes;

a third step of mixing the dispersion prepared in the first step and the metal salt solution and the disperse solution of carbon nanotubes prepared in the second step to prepare a composite that metal or metal oxide nanoparticles are formed an the graphene surfaces; and

a fourth step of forming nanopores on the graphene surfaces through a catalytic combustion of the composite prepared in the third step.

The process for producing the graphene composite of porous structure according to the present invention is carried out by a solution process to embody effects of process simplification and cost savings.

The process for producing a porous graphene of the present invention is a simple process by forming metal or metal oxide nanoparticles on the graphene powder, over the conventional technique of forming pores on one graphene after synthesizing a single layer of graphene, and is capable of effectively controlling physical-chemical properties of graphene, and is characterized by having pores with various site, shape and distribution on graphene depending on particle size, particle shape and particle distribution of metal or metal oxide by inducing to generate the thermal decomposition of graphene in the area of metal or metal oxide nanoparticles present on the graphene surfaces at a temperature lower than the thermal decomposition temperature of graphene, instead of forming pores through etching using a mold.

The process for producing the graphene composite of porous structure is explained in detail in a stepwise manner as follows.

The first step is a step of producing a dispersion of graphite oxide. Here, the graphite oxide may be one prepared through the Modified Hammer method by mixing graphite with sulfuric acid (H₂SO₄) and potassium permanganate (KMnO₄), stirring the mixture at room temperature for 2 hours or more, and adding hydrogen peroxide (H₂O₂), when the color of the solution turns yellow, to complete the reaction, followed by carrying out centrifugation via the drying procedure.

The dispersion of graphite oxide uniformly dispersed may be prepared by adding 0.01 to 1 part by weight of the graphite oxide based on 100 parts by weight of water, followed by the ultrasonic treatment.

The second step is a step of preparing the metal salt solution and the carbon nanotube disperse solution. The uniformly mixed metal salt solution and the uniformly carbon nanotube disperse solution may be prepared by mixing the metal salt and the solvent in a ratio of 1:1 and also mixing the carbon nanotubes and the solvent in a ratio of 1:1, followed by sonic treatment of two solutions, respectively. In addition, the ratio of the metal salt and the carbon nanotubes herein may be in the range of 1:3 to 1:9 or 1:5 to 1:6 based on parts by weight. For carbon nanotubes herein, a procedure for controlling the surface charge may be performed prior to producing the mixed solution, and specifically nitrogen may be doped by mixing a nitric acid solution and a sulfuric acid solution in a ratio of 1:3 to introduce an oxygen functional group to the carbon nanotube surface by the acid treatment, and then through the heat treatment (about 900° C.) in an ammonia gas atmosphere, in order to control the surface charge.

As the solvent, water, ethylene glycol, diethylene glycol, triethylene tetraethylene glycol, or tetratethylene glycol, and the lke may be used alone or in a combination of two or more thereof, and as the solvent herein, water may be used.

The metal salt is preferably included in 0.01 to 30 parts by weight relative to 1 part by weight of graphene, since the deposition amount of metal or metal oxide deposited on the graphene surface can be controlled depending on the content. If the content is less than 0.01 parts by weight, it is difficult to expect the effect of the synthesized metal and metal oxide, whereas if it is more than 30 parts by weight, it is difficult to disperse on the graphene in the synthesis step. The kinds of metal salt may include pearl chloride, ruthenium chloride or tin chloride, and specifically tin chloride (SnCl₂) may be used.

The third step is a step of mixing the dispersion prepared in the first step and the metal salt solution and the disperse solution of carbon nanotubes prepared in the second step to prepare a composite that metal or metal oxide nanoparticles are formed on the graphene surfaces. Here, in order that the size of the nanopores and the distance between the pores are substantially uniform and the lamination of the graphene oxide is inhibited under synthesis, sonication and stirring about the mixed solution were simultaneously performed within the thermostat set at the ambient temperature (about 25° C.) for about 4 hours. At this time, the sonication and the stirring need not necessarily utilize at the same time, but at least one of the two is adapted. At this time, since a phenomenon that the metal oxide is not uniform or the graphene is re-laminated may occur on applying heat or using a chemical method, it is preferred to use at least one of sonication and stirring as a physical method. Subsequently, it is possible by carrying out a process for filtering and/or lyophilizing the solution subjected to sonication and stirring to obtain a composite that the metal oxide nanoparticles are formed on the graphene surfaces. According to this example, the above treatment may be performed at room temperature, wherein such a process at room temperature can prevent from reducing graphite oxide on coating metal oxides to be re-laminated.

The composite that metal oxide nanoparticles are formed on the graphene surfaces may be prepared by heat treating the mixed solution of the dispersion of graphite oxide, the metal salt solution and the disperse solution of carbon nanotubes, but the composite may be also prepared at room temperature, without being not particularly limited thereto.

When performing the above heat treatment, the heat treatment may be carried out at the boiling point or more of the mixed solution, and more specifically, at 160 to 300° C. If the temperature is less than 160° C., the synthesis efficiency of the metal or metal oxide decreases, whereas if it is more than 300° C., it is due to be experimentally dangerous by exceeding the temperature range of the microwave synthesis equipment. In addition, the heat treatment may be conducted by applying a microwave to the mixed solution for 5 to 60 minutes. The microwave may be a microwave of frequency having the energy intensity to not disassemble the molecular structure of the solvent in the mixed solution. More specifically, it may have a frequency of 2 to 60 GHz.

More specifically, when the graphene powders in the mixed solution are heated by the microwave with a solvothermal method, the metal salts in the mixed solution may be formed on the graphene surfaces into a shape of metal or metal oxide nanoparticles by heating them at a relatively high temperature over the solvent to cause selective heterogeneous nucleation and growth of metal or metal oxide on their surfaces, to synthesize the composite of the metal/graphene or metal oxide nanoparticles/graphene. Here, the metal oxide nanoparticles/graphene composite may refer to the composite that metal oxide nanoparticles are formed on the graphene surfaces.

In the synthesis of the metal oxide nanoparticles/graphene composite, it is possible to add water to the mixed solution. The addition of water is to enable the synthesis of the metal oxide without an additional heat treatment step by causing a forced hydration action upon performing the polyol synthesis method. Water used in preparation of the metal oxide nanoparticles/graphene composite manufacture can be included to 2 with respect to 100 parts by weight of a mixed solution of 90 parts by weight. If the content is less than 2 parts by weight, the transition metal is synthesized in the form of metal instead of oxides after the synthesis, whereas if it is more than 90 parts by weight, it is due to decrease the synthesis efficiency of the synthesized transition metal oxide.

The diameter of the metal or metal oxide nanoparticles synthesized via the heat treatment may be 1 to 50 nm. In addition, the metal oxide nanoparticles/graphene composite prepared in the above steps may further comprise cleaning and drying steps.

More specifically, the composite may be cleaned with ethanol or water, and then dried at 80 to 120° C., or freeze-dried at −20 to −60° C. for 48 to 72 hours, without being particularly limited thereto.

In addition, the step of forming the metal oxide nano-particles/graphene composite comprises a procedure of reduction into graphene. For example, graphite is synthesized into graphite oxide through the oxidation treatment. The graphite oxide is peeled into graphene oxide through the ultrasonic treatment. The graphene oxide is reduced to graphene through a reducing gent (diethylene glycol) and/or heat treatment (microwave treatment), with removing oxygen (reduced graphene oxide), and if the metal salt is added under the procedure of reduction, the metal oxide nanoparticles/graphene composite may be formed by forming, the metal or metal oxide nanoparticles on the graphene (reduced graphene oxide) surfaces. More specifically, the graphene oxide in the metal oxide nanoparticles/graphene composite may be reduced to graphene (or reduced graphene oxide) on treating at 160 to 300° C. for 30 minutes to 2 hours under water or polyol.

The fourth step may be a step of forming nanopores on the graphene surfaces through a catalytic combustion of the metal oxide nanoparticles/graphene composite prepared in the third step. That is, it is a step of forming nanopores on the graphene surfaces through the selective combustion of the graphene surrounding the metal catalyst by heat treating the metal oxide nanoparticles/graphene composite.

The catalytic combustion may be performed by heat treating the metal oxide nanoparticles/graphene composite in a heating furnace or applying a microwave, so as to generate the thermal decomposition of graphene in the area having metal or metal oxide present on the graphene surfaces at a temperature lower than the thermal decomposition temperature of graphene, but is not particularly limited thereto.

The process for producing the graphene composite of porous structure of the present invention may further comprise a step of removing metal or metal oxide nanoparticles from the composite forming pores on the surfaces. The metal or metal oxide nanoparticles may be removed by a chemical method, but is not particularly limited thereto. The chemical method can vary depending on the kinds of metal, without any particular limitation, but in the case of most transition metal oxides, they may be removed in acid such as IM or more nitric acid, sulfuric acid, or hydrochloric acid, etc. Also, ruthenium, and the like may be removed, for example, in 1M or more KOH, or NaOH.

Furthermore, the metal oxide nanoparticles/graphene composite may be heated from room temperature to about 300° C. at a heating rate per minute of 2.5° C., and subsequently heated from 430° C. to 450° C. at a heating rate per minute of 10° C., with finally maintaining this temperature in the corresponding temperature for about 1˜3 hours, in order to remove the metal oxide nanoparticles, and then the heat treatment may be performed in an oven at 80° C. for 4 hours after adding to hydroiodic acid (HI), in order to dissolve the metal oxide of the composite.

From the porous graphene removing the metal or metal oxide nanoparticles with the above method, the graphene of porous structure may be prepared via cleaning and drying steps. More specifically, the porous graphene may be cleaned with ethanol or water, and then dried at 80 to 120° C., or freeze-dried at −20 to −60° C. for 48 to 72 hours, without being particularly limited thereto.

Furthermore, the present invention provides an electrode comprising the graphene composite of porous structure. The present invention also provides any one product of secondary batteries, fuel cells, supercapacitors, sensors, membranes, or transparent conductive films, comprising the graphene composite of porous structure of the present invention. Since the graphene composite of porous structure of the present invention has large surface area over the non-porous graphene compositie, and has high chemical, electrochemical activity of the edge surface introduced via formation of pores over the basal surface, so that the performance can be improved through use of the edge surface, it may be used in secondary batteries, fuel cells, supercapacitors, sensors, membranes, or transparent conductive films, etc. In addition, the porous graphene of the present invention can further comprise metal or metal oxide nanoparticles it the nanopores, wherein the nanoparticles may be usefully applied to membranes, transparent conductive films, and the like, requiring electrical conductivity and permeability.

### EXAMPLES

Hereinafter, the present invention is explained in more detail through examples according to the present invention, but the scope of the present invention is not limited by the examples set forth below.

### Preparation Example 1

### Preparation of Graphite Oxide

This example is a step of preparing graphite oxide through the modified Hummer method, and the reaction was completed by mixing the commercially available graphite (product name: Graphite, manufacturer; Sigma Aldrich) with sulfuric acid (H₂SO₄) and potassium permanganate (KMnO₄), stirring the mixture at room temperature for 2 hours or more, and adding hydrogen peroxide (H₂O₂), when the color of the solution turned yellow. After completion, the centrifugation was carried out via the drying procedure to obtain graphite oxide in a form of fine powder.

### Example 1

### H-SCNT/NPG Production

[Step 1] Step of Preparing Graphite Oxide Dispersion

The graphite oxide dispersion was prepared by adding 1 g of the graphite oxide powder obtained in Preparation Example 1 to 1L of water of pH 6˜7.5 (about 5° C.) and ultrasonic treating the mixture for 40 minutes so as to disperse graphite oxide uniformly of 7.5 for 40 minutes.

[Step 2] Step of Preparing Metal Salt Solution and Carbon Nanotube Solution

To control the surface charge of the commercially available carbon nanotubes (manufacturer: Korea JCC, product name: CNT M95), a nitric acid solution and a sulfuric acid solution were mixed in a ratio of 1:3 to introduce oxygen functional groups to the carbon nanotubes, and then nitrogen was doped through heat treatment (about 900° C.) in an ammonia gas atmosphere to control the surface charge of the carbon nanotubes. Then, the metal salt solution and the carbon nanotube solution were prepared by mixing 160 mg of the nitrogen doped carbon nanotubes and 160 ml of water, followed by sonication, and mixing 30 mg of tin chloride (SnCl₂) and 30 ml of water, followed by sonication.

[Step 3] Step of Forming SnO₂/Graphene Composite

The graphite oxide dispersion prepared in the above Step 1 and the metal salt solution and the carbon nanotube solution, prepared in Step 2, were mixed to prepare a mixed solution. At this time, in order that the size, of the nanopores and the distance between the pores are substantially uniform, and the, lamination of the graphene oxide is inhibited under synthesis, sonication and stirring about the mixed solution, were simultaneously performed within the thermostat set at the ambient temperature (about 25° C.) for about 4 hours. Subsequently, the SnO₂/graphene composite that the SnO₂ particles were formed on the graphene surfaces was obtained by carrying out a process for filtering and/or lyophilizing the solution subjected to sonication and stirring (prior to heat treatment, the porous structure is not formed).

[Step 4] Step of Preparing Graphene Composite of Porous Structure

The SnO₂/graphene composite powder obtained in the above Step 3 was first heated from room temperature to about 300° C. at a heating rate per minute of 2.5° C. (first stage), and subsequently heated from 430° C. to 450° C. at a heating rate per minute of 10° C. (second stage), with finally maintaining this temperature in the corresponding temperature for about 1˜3 hours. Then the heat treatment was performed in an oven at 80° C. for 4 hours after adding 1 mg/mL of SnO₂/graphene composite (solid, phase) synthesized by parts by weight to hydroiodic acid (HI) to remove the metal oxide, in, order to dissolve the metal oxide of the SnO₂/graphene composite. Then, after cleaning through the filtering process (using deionized water), the graphene composite of porous structure was obtained via the freeze-drying process. At this time, the average pore diameter of the resulting graphene composite of porous structure was about 10.61 nm.

In the present invention, H-SCNT/NPG means that the SCNT (carbon nanotubes) content is higher than L-SCNT/NPG.

### Example 2

### L-SCNT/NPG Production

The composite was prepared in the same manner as Example 1 above except for adding carbon nanotubes (manufacturer: Korea JCC, product name: M95 CNT) in 110 mg parts by weight. At this time, the average pore diameter of the resulting graphene composite of porous structure was about 7.32 nm.

In the present invention, L-SCNT/NPG means that the SCNT (carbon nanotubes) content is lower than H-SCNT/NPG.

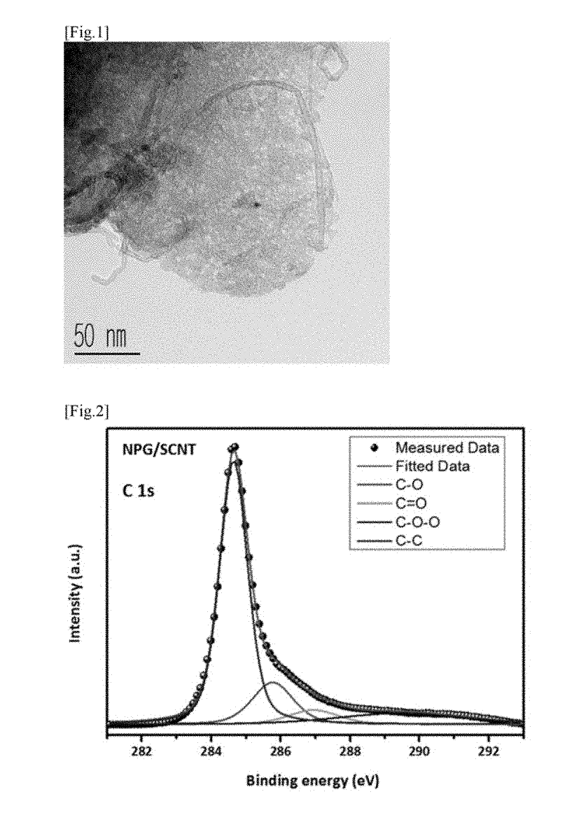

FIG. 1 is a TEM photograph of the graphene composite of porous structure prepared according to Example 1, Referring to FIG. 1, it can be seen that the pores having an average diameter of about 5 nm are formed on the surface, and the appearance can be seen, in which carbon nanotubes having an average diameter of about 8 nm are formed into a composite.

FIG. 2 is a graph of the results analyzing X-ray photoelectron spectroscopy (XPS) of the graphene composite of porous structure according to Example 1, Referring to FIG. 2, the C—C orbital at about 284.6 eV, and the C—O, C═O, and C═O functional groups present on the surface at 286.1 eV, 287.0 eV and 288.4 eV can be determined. In addition, in the case of the composite prepared in Example 1, it can be confirmed that the C—C peak increases, which means that the electrochemical properties have been improved.

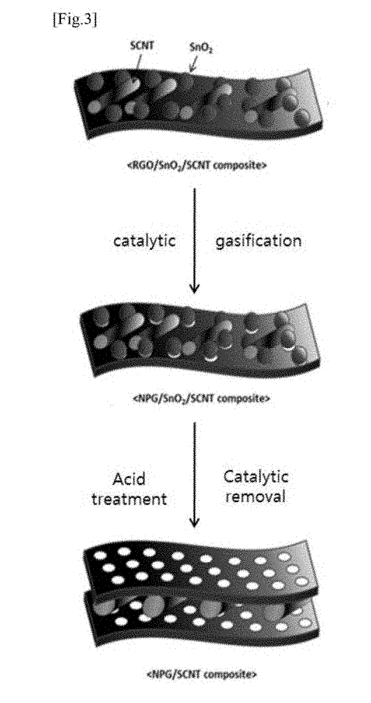

FIG. 3 simply shows procedures of preparing the graphene composite of porous structure according to the present invention.

### Example 3

An electrode slurry was prepared by mixing 90 parts by weight of the graphene composite of porous structure prepared in. Example 1 and 10 parts by weight of polyvinylidene fluoride (PVDF) as a binder and adding the mixture to N-methyl-2-pyrrolidone (NMP), and then this slurry was applied on an aluminum current collector by 1˜2 mg and dried to prepare an electrode. Then, a full cell was prepared using TEABF₄/ACN as an electrolyte.

### Comparative Example 1

### Graphene (NPG) Composite Production

The graphene composite was prepared m the same manner as Example 1 except for adding no carbon nanotubes. At this time, the as pore diameter of the graphene composite Was 5 to 20 nm.

### Comparative Example 2

### Graphene/Carbon Nanotube Composites (Graphene/SCNT) Production

The graphene composite was prepared in the same manner as Example 1 except for forming no pore on the graphene due to no addition of tin chloride.

### Comparative Example 3

The full cell was prepared in the same manner as Example 3 except for using the composite prepared in Comparative Example 1 instead of the composite prepared in Example 1.

### Comparative Example 4

The full cell was prepared in the same manner as Example 3 except for using the composite prepared in Comparative Example 2 instead of the composite prepared in Example 1.

### Experimental Example 1

### Measurement of Specific Surface Area of the Composite

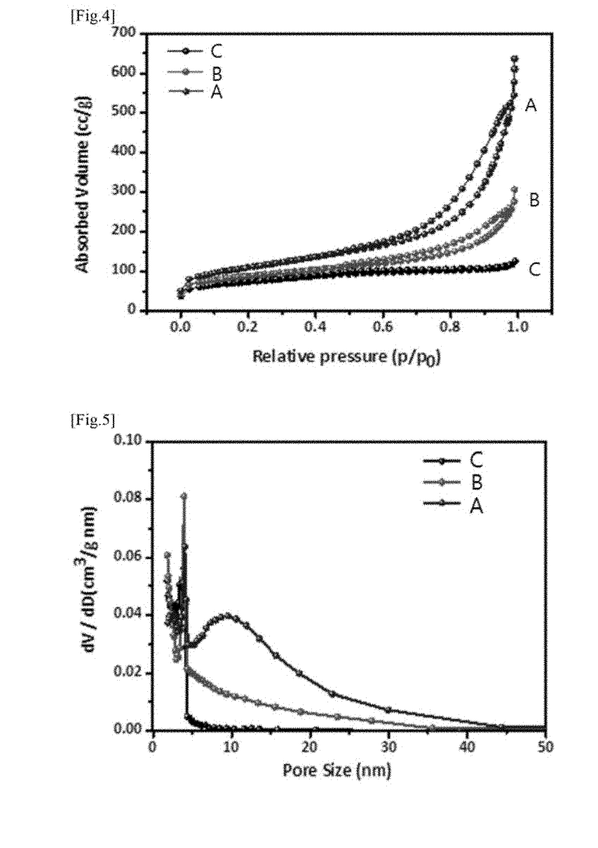

To determine the specific surface areas of the composites according to Example 1, Example 2 and Comparative Example 1 above, N₂ adsorption isotherms (sorption isotherms) were measured. The results were shown in FIG. 4. Referring to FIG. 4, the specific surface area (A in FIG. 4) of Example 1 was found to be about 392 m²/g, the specific surface area (B in FIG. 4) of Example 2 about 316 m²/g and the specific surface area (C in FIG. 4) of Comparative example 1 about 257 m²/g. Thus, it could be seen that the graphene composite of porous structure of the present invention compounding the graphene of porous structure and the carbon nanotubes has outstandingly unproved specific surface area over Comparative Example 1 without compounding carbon nanotubes.

### Experimental Example 2

### Measurement of Pore Volume Fraction and Average Pore Diameter of the Composite

The pore volume and the average pore diameter of the composites according to Example 1, Example 2 and Comparative Example 1 above were measured. Referring to FIG. 5 as the results, the pore volume (A in FIG. 5) and the average pore diameter of the composite according to Example 1 were found to be about 1.00 cm³/g and about 10.61 nm, respectively, and the pore volume (B in FIG. 5) and the average pore diameter of the composite according to Example 2 were found to be about 0.45 cm³/g and about 7.32 nm, respectively. On the contrary, it can be seen that the pore volume (C in FIG. 5) of Comparative Example 1 is only about 0.15 cm³/g and the average pore diameter is only about 3.6 nm. Accordingly, it could be seen that the graphene composite of porous structure according to the present invention has improved pore volume and average pore diameter over Comparative Example 1 without including carbon nanotubes.

### Experimental Example 3

### Evaluation of Electrochemical Properties

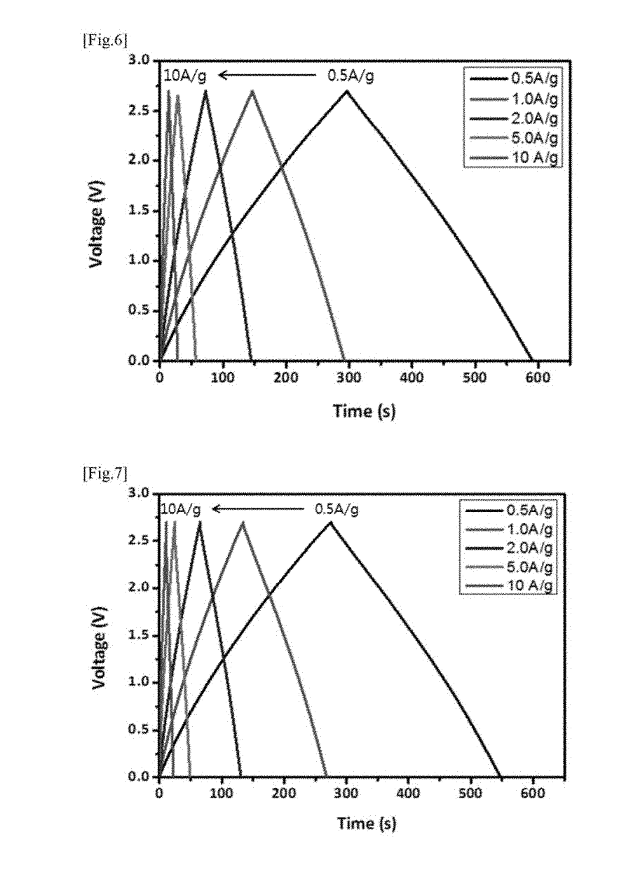

To measure specific capacitances of full cells according to Example 3 and Comparative Example 4, glavanostatic charge/discharge test was performed at a constant current of 0.5 A/g, 1.0 A/g, 2.0 A/g, 5.0 A/g and 10 A/g and a voltage in the range of 0 V to 2.7 V, and the results were shown in FIGS. 6 and 7. FIGS. 6 and 7 represent charge-discharge curves of full cells according to Example 3 and Comparative Example 4, respectively. At this time, each specific capacitance (Cₛₚ) was measured by Formula 1 below.

$${C}_{sp} = \frac{i ( A ) \times Δ t ( s )}{Δ E ( V ) \times m ( g )} \qquad [ Formula 1 ]$$

In Formula 1, i represents a discharge current, Δt represents a discharge time, ΔE represents an electrochemical potential window, and m represents the total mass of the composite.

The specific capacitances of full cells according to Example 3 and Comparative Example 4 determined from FIG. 6 and FIG. 7 were measured as shown in Table 1 below.

TABLE 1

| Classi- | | | | | | Rate |
|---|---|---|---|---|---|---|
| fication | 0.5 A/g | 1.0 A/g | 2.0 A/g | 5.0 A/g | 10 A/g | Property |
| Ex. 1 | 220 F/g | 215 F/g | 214 F/g | 211 F/g | 207 F/g | 94.1% |
| Com. Ex. 1 | 205 F/g | 198 F/g | 193 F/g | 182 F/g | 165 F/g | 80.4% |

(Ex.: Example, Com. Ex.: Comparative Example)

According to Table 1, in the case of the full cell comprising the graphene composite of porous structure according to the present invention, the specific capacitances in each current condition were higher than those of the full cell comprising the composite of Comparative Example 2, and as the rate property from the property of high rate (10 A/g) relative low rate (0.5 A/g) is 94/1%, it can be seen that the property is significantly higher over the full cell of Comparative Example 3.

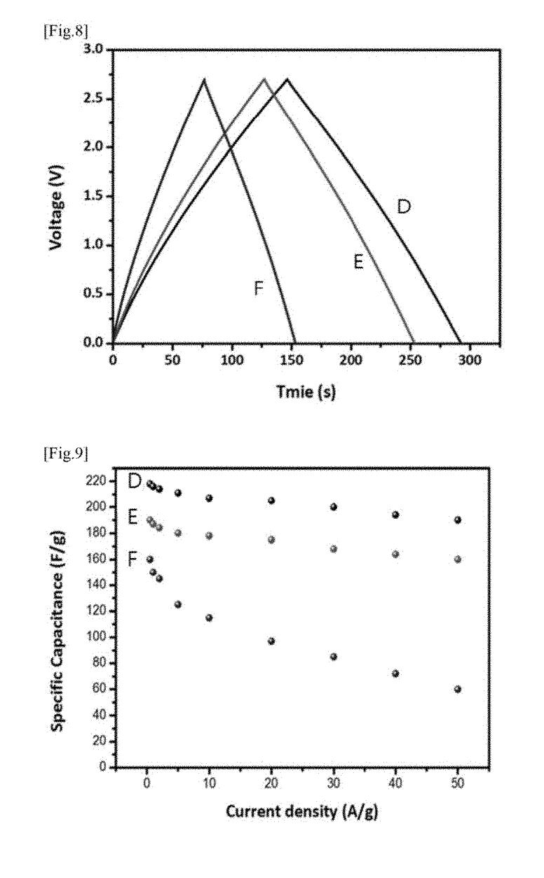

In addition, FIG. 8 and FIG. 9 show charge-discharge curves and specific capacitance graph of the full cell (D) according to Example 3, the full cell (E) according to Comparative Example 3 and the full cell (F) prepared by only graphene. According to FIG. 8 and. FIG. 9, it can be seen that the full cell (D) comprising the composite according to the present invention has high charge-discharge capacity and specific capacitance over the full cell (E) according to Comparative Example 3.

Accordingly, it could be seen that the composite according to the present invention has increased ioinic conductivity by forming a relatively large number of holes on the graphene to move ions smoothly.

FIG. 10 is cyclic voltammograms of the fullcell according to Example 3, and it can be seen that the ionic conductivity has been highly improved when it was prepared by the graphene composite of porous structure according to the present invention. In addition, it, can be seen that even if the voltage is increased, the hysteresis curve of current-potential is maintained, which shows that the effect is greater on applying the graphene composite of porous structure of the present invention to the supercapacitor.

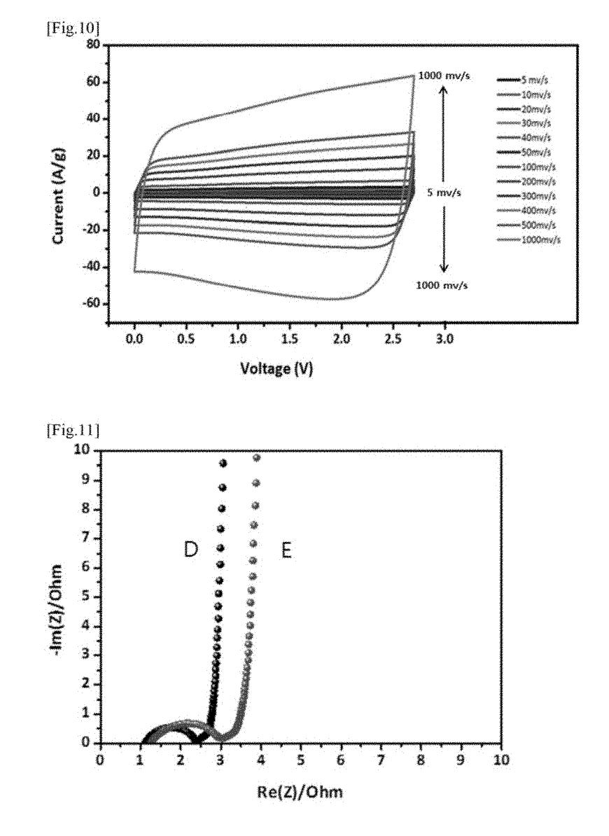

In addition, FIG. 11 depicted electrochemical impedance spectroscopy (EIS) data of the full cell (D in FIG. 11) according to Example 3 and the full cell (E in FIG. 11) according to Comparative Example 3. According to FIG. 11, it could be seen that the graphene composite of porous structure according to the present invention has decreased ohmic resistance and charge transfer resistance by containing the carbon nanotubes. Accordingly, it was confirmed that the cell utilizing the graphene composite of porous structure according to the present invention could exhibit excellent electrochemical properties.

What is claimed is:

1. A graphene composite of a porous structure comprising:
a laminate which is laminated by two or more layers of reduced graphene (rGO) in which a plurality of holes are formed; and
carbon nanotubes present in the interface(s) between the layers of the reduced graphene (rGO) forming the laminate.

2. The graphene composite of porous structure according to claim 1, wherein
a BET specific surface area of the graphene composite of porous structure is in the range of 100 to 700 m²/g.

3. The graphene composite of porous structure according to claim 1, wherein
the content ratio of the reduced graphene (rGO) and the carbon nanotubes in said graphene composite of porous structure is in the range of 10:0.5 to 9 (by weight).

4. The graphene composite of porous structure according to claim 1,
characterized in that the average diameter of the carbon nanotubes is in the range of 1 to 50 nm.

5. The graphene composite of porous structure according to claim 1,
characterized in that the average diameter of the holes formed in the reduced graphene (rGO) is a porous structure, characterized in that in the range of 0.5 to 40 nm.

6. An electrode comprising the graphene composite of porous structure according to claim 1.
